(19) United States
(12) Patent Application Publication
(10) Pub. No.: US 2024/0046787 A1
(43) Pub. Date: Feb. 8, 2024

(54) Method And System For Traffic Clearance At Signalized Intersections Based On Lidar And Trajectory Prediction

(71) Applicant: TONGJI UNIVERSITY, Shanghai (CN)

(72) Inventors: Ting Fu, Shanghai (CN); Junhua Wang, Shanghai (CN); Shengbin Xie, Shanghai (CN); Shuo Liu, Shanghai (CN)

(21) Appl. No.: 17/620,674

(22) PCT Filed: Sep. 9, 2021
(86) PCT No.: PCT/CN2021/117350

§ 371 Date: Dec. 17, 2021

(30) Foreign Application Priority Data
Apr. 8, 2021 (CN) 202110379124.5

(51) Int. Cl. G08G 1/082; G01S 17/931; G01S 17/58; G08G 1/052; G08G 1/01

(52) U.S. Cl. CPC G08G 1/082; G01S 17/931; G01S 17/58; G08G 1/052; G08G 1/0129

(57) ABSTRACT

The invention discloses a method and system for traffic clearance at signalized intersections based on lidar and trajectory prediction, belonging to the field of intelligent transportation systems. The invention obtains live vehicle trajectory data at the entrance of the intersection based on 3D LiDAR, and predicts whether a motor vehicle will enter at the signalized intersection when traffic light changes from green to red (which normally involves the yellow change interval). It uses the 3D LiDAR installed at the intersection covering the entrance to collect the trajectory data of the vehicle, and further judges whether the vehicle will enter the intersection after the yellow change interval; it also predicts the driving time of the entered vehicle in the intersection, and determines the all-red time of the intersection on this basis, so as to achieve the purpose of clearing the traffic within the intersection in time and reducing traffic conflicts.

### BACKGROUND OF THE INVENTION

### 1. Field of the Invention

The invention belongs to the field of intelligent transportation systems, and specifically relates to a method and system traffic clearance at signalized intersections based on lidar and trajectory prediction.

### 2. Description of the Relater Art

The intersection of urban roads is the “throat” of the capacity of the urban road network, and it is also a frequent occurrence area of urban traffic accidents. According to statistics from the traffic police department, more than 60% of traffic accidents that occur on urban roads are within the range of intersections. Most of the accidents occurred during the green light interval, that is, the period from the end of the green light of the traffic signal of the previous phase to the beginning of the green light of the next phase. Because at the end of the green phase, the long phase transition time leads to heterogeneous decision-making. Therefore, dangerous driving behaviors are more likely to occur at these intersections, such as red-light driving, sudden stopping, aggressive driving, and inconsistent decisions of the front and rear vehicles, which may lead to right-angle and rear-end collisions.

For the dangerous driving behaviors that exist during the current intersection phase change, the existing solutions mostly focus on preventing the occurrence of dangerous behaviors. For example, by increasing the yellow light duration, setting the signal countdown and other simple signal timing adjustment methods to reduce the probability of driving the red light; by promulgating laws and regulations, installing a red light capture system, and intensifying the punishment to reduce the occurrence of red light running; recently, some scholars have proposed to use vehicle-road coordination to realize early warning on the vehicle side through intelligent equipment facilities and communication between the equipment and the vehicle. However, in these existing methods, one aspect is to prevent the occurrence of dangerous behaviors, and the other is that they require sufficient support from smart devices on the roadside and vehicle terminal, and they do not have sufficient adaptability and safety prevention and control efficiency.

Therefore, the invention proposes a method and system traffic clearance at signalized intersections based on lidar and trajectory prediction.

### SUMMARY OF THE INVENTION

In order to overcome the above shortcomings in the prior art, the invention provides a method and system traffic clearance at signalized intersections based on lidar and trajectory prediction.

In order to achieve the above objectives, the invention provides the following technical solutions:
step 1: use the 3D LiDAR installed at the intersection covering the entrance of the urban intersection to obtain live vehicle trajectory data based on 3D LiDAR, and to detect the vehicles that are about to enter the intersection;
step 2: map the vehicle trajectory data obtained by the 3D LiDAR into a three-dimensional coordinate system within the range of the entrance, and classify the vehicles according to the lane where the vehicle is located;
step 3: after receiving the start signal of the yellow light, input the vehicle trajectory data obtained within the first 1.5 s of the yellow light time into the trajectory prediction model; predict the vehicle trajectory within the last 1.5 s of the yellow light time based on the trajectory prediction model;
step 4: based on the vehicle trajectory data within the last 1.5 s after the yellow light time, identify whether the vehicle will enter the intersection after the yellow change interval; if yes, continue to predict the travel time of all vehicles that have entered the intersection as a result of the prediction, and further filter to obtain the maximum time for the entered vehicle to leave the intersection; if not, return to step 1 to continue detection;
wherein, the travel time of the vehicle in the intersection refers to the time from when the vehicle enters the intersection at the end of the yellow light to when it leaves the intersection;
step 5: determine the all-red time of the intersection according to the obtained maximum time for the entered vehicles to leave the intersection.

Preferably, the three-dimensional coordinate system is established before the vehicle trajectory data is obtained; the coordinates of the stop line at the intersection, the coordinates and range of the lane, and the information of the lane are input in the three-dimensional coordinate system.

Preferably, the vehicle trajectory data comprises: the ID of the vehicle, the speed of the vehicle, the acceleration of the vehicle, and the distance of the vehicle from the stop line; the start signal of the yellow light specifically comprises the real-time phase information of the intersection, that is, the current phase and the duration of the current phase.

Preferably, the trajectory prediction model in step 3 is established based on historical vehicle trajectory data, and the establishment of the trajectory prediction model comprises the following steps:
step 3.1: collect historical vehicle trajectory data within 3 s of the yellow light time to form a vehicle trajectory data set A;
step 3.2: perform cluster analysis on the vehicle trajectory data set A to obtain cluster center trajectory data; divide the data of the vehicle trajectory data set A into i categories according to the clustering results; use the i categories as i trajectory labels, and each category corresponds to one trajectory label;
step 3.3: divide the vehicle trajectory data set A into a training set B and a test set C; take the trajectory data of the training set B and the trajectory label corresponding to each trajectory as input, establish a convolutional neural network learning model to learn historical vehicle trajectory data and the corresponding label thereof;
step 3.4: train the model until the model is tested with the test set C; when the test value reaches the expected accuracy rate, the establishment of the trajectory prediction model is completed.

Preferably, the vehicle trajectory data or historical vehicle trajectory data are all divided into a straight-going vehicle data set, and/or a left-turning vehicle data set, and/or a right-turning vehicle data set.

Preferably, the step 3 specifically comprises the following steps:
input the vehicle trajectory data obtained in the first 1.5 s of the yellow light time into the trajectory prediction model established in advance, and the trajectory prediction model predicts and obtains the trajectory label to which the trajectory data belongs; according to the predicted trajectory label, select the trajectory data within the last 1.5 s after the yellow light time of the cluster center trajectory data of the category corresponding to the trajectory label, which is the predicted trajectory data of the vehicle within the last 1.5 s after the yellow light time; then use the trajectory data to determine the passing trend of the vehicle after the yellow light ends and predict the trajectory data of the vehicle at the stop line.

Preferably, the 3D LiDAR knows whether a single vehicle or a vehicle queue is passing in each lane of the entrance at this time by detecting the vehicles at the entrance of the intersection; the prediction in step 3 is divided into two scenarios: single vehicle passing prediction and vehicle queue passing prediction;
the specific prediction process for a single vehicle is: after receiving the start signal of the yellow light, determine the phase of the yellow light at this time, and different phases need to predict and discriminate the corresponding lane vehicles; if it is the yellow light of the straight-going phase at this time, after receiving the start signal of the yellow light, the system only needs to predict and discriminate the vehicles on the straight-going lane at this time; if it is the yellow light of the left-turning phase at this time, after receiving the start signal of the yellow light, the system only needs to predict and discriminate the vehicles on the left-turning lane at this time;
the specific prediction process for a vehicle queue is: when the 3D LiDAR collects vehicle trajectory data, all vehicles are collected together as a whole; when predicting and discriminating each vehicle entry, it starts with the first vehicle in the queue, and then predicts and discriminates one by one; in the one-by-one discrimination, if it is judged that a certain vehicle will not enter the intersection at the end of the yellow light, all the vehicles in the queue after the vehicle are judged to not enter the intersection at the end of the yellow light.

Preferably, the specific content of predicting the travel time of all vehicles that have entered the intersection as a result of the prediction is as follows:
within the range of the entrance, collect the data of the vehicles entering the intersection after the current phase yellow light ends and the red light is on, and predict the trajectory and travel time of the vehicle in the intersection according to the lane where the vehicle is located; if the vehicle is on the straight-going lane, its trajectory is predicted to go straight through the intersection and leave; if the vehicle is on the left-turning lane, its trajectory is predicted to turn left into the left road and leave the intersection;
based on the predicted speed of the vehicle entering the intersection at the end of the yellow light and the predicted trajectory of the vehicle within the intersection, by assuming that the vehicle will pass through the intersection at the end of the yellow light at a constant speed that the predicted vehicle enters the intersection, the travel time of the vehicle in the intersection can be predicted; compare the predicted travel time of each vehicle in the intersection to obtain the maximum time t for the entered vehicles to leave the intersection.

Preferably, the specific content of determining the all-red time of the intersection is:
with the obtained maximum time t for the entered vehicles to leave the intersection, set the time t as a new all-red time, so as to ensure that the last entered vehicle can leave the intersection within the all-red time, which achieves the purpose of clearing the traffic within the intersection in time and reducing traffic conflicts between vehicles in different phases.

Another purpose of the invention is to provide a system traffic clearance at signalized intersections based on lidar and trajectory prediction, comprising a detection module, a data processing module, a data prediction module, and a signal control management module;
the detection module is configured to obtain the vehicle trajectory data at the entrance of the urban intersection;
the data processing module is configured to analyze and process the obtained vehicle trajectory data;
the data prediction module is configured to predict the trajectory of the vehicle, identify whether the vehicle will enter the intersection, and predict the travel time of the entered vehicle in the intersection;
the signal control management module is configured to obtain the information of the signal light and adjust the all-red time of the signal light.

The method and system traffic clearance at signalized intersections based on lidar and trajectory prediction of the invention has the following advantageous effects.

1. The equipment used in the method of the invention to detect vehicle trajectory data is a 3D LiDAR equipment fixed on the side of the entrance. It uses historical and real-time radar data, which has the advantages of reasonable cost, high accuracy, low calculation requirements, and adaptability to all-weather road environments. High-precision real-time running trajectories of motor vehicles can be obtained. At the same time, the information processing of lidar is more efficient than other detection methods such as video detection. Therefore, real-time trajectory prediction can be realized, and analysis and processing can be made in time, so as to achieve accurate, efficient, stable and all-weather detection of signals to control the driving behavior of the vehicle during the phase change of the intersection.

2. The invention provides a complete set of solutions from prediction to prevention and control for the traffic safety problem of vehicle intrusion during the phase change of signal lights at urban signal control intersections. This solution can stably, accurately and efficiently identify and predict dangerous behaviors during the phase change of traffic signals. On this basis, through the determination of the all-red time of the intersection signal lights, the purpose of clearing the traffic within the intersection range in time and reducing traffic conflicts is achieved. It can further reduce the potential safety hazards of vehicles during the phase change of the intersection, reduce the occurrence of accidents at the intersection, and improve the operational safety level of urban roads.

3. In terms of detection method of the invention, the continuous trajectory of the vehicle can be accurately obtained based on the data obtained by the 3D LiDAR, and subsequent analysis and prediction can be performed, without relying on vehicle-end equipment such as high-precision GPS; in terms of prevention and control measures, it is only necessary to add an adjustment module to the all-red time on the basis of the existing intersection signal control system, and no additional cumbersome accessories are required. Therefore, the required cost of the equipment is low, and the adaptability to the existing traffic environment is higher.

### BRIEF DESCRIPTION OF THE DRAWINGS

In order to describe the embodiments of the invention and the design solutions thereof more clearly, the drawings required by the embodiments will be briefly introduced hereinafter. The drawings in the following description are only part of the embodiments of the invention. For those of ordinary skill in the art, other drawings can be obtained based on these drawings without creative work.

FIG. 1 is a schematic diagram of the work flow of a method for traffic clearance at signalized intersections based on lidar and trajectory prediction according to Embodiment 1 of the invention.

FIG. 2 is a flow chart of establishing the trajectory prediction model provided by an embodiment of the invention.

### DETAILED DESCRIPTION OF THE PREFERRED EMBODIMENTS

In order to enable those skilled in the art to better understand and implement the technical solutions of the invention, the invention will be described in detail hereinafter with reference to the drawings and specific embodiments. The following embodiments are only used to illustrate the technical solutions of the invention more clearly, and cannot be used to limit the protection scope of the invention.

### Embodiment 1

The invention provides a system traffic clearance at signalized intersections based on 3D LiDAR and vehicle trajectory prediction in order to overcome the safety problems existing in road intersections. The system comprises a detection module, a data processing module, a data prediction module, and a signal control management module; the detection module uses 3D LiDAR to collect vehicle trajectory data at the entrance, and the detection is more accurate, stable and efficient; the data processing module is configured to analyze and process the obtained vehicle trajectory data; the data prediction module is configured to predict the trajectory of the vehicle, identify whether the vehicle will enter the intersection, and predict the travel time of the entered vehicle in the intersection; the signal control management module is configured to obtain the information of the signal light and adjust the all-red time of the signal light.

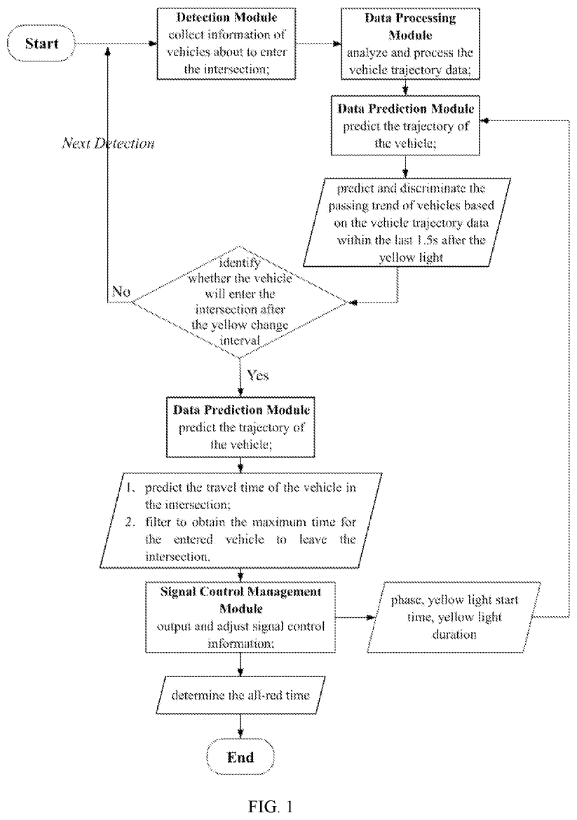

Based on a general inventive concept, the invention further provides a signal control intersection clearing method based on 3D LiDAR and vehicle trajectory prediction. The method makes full use of the data detected by 3D LiDAR, and uses the vehicle's kinematics characteristics and trajectory prediction to realize real-time detection of vehicles about to enter the intersection within the duration of the yellow light and predict whether the vehicle will enter the intersection at the end of the yellow light, then, by adjusting the all-red time of the signal light in the intersection, the purpose of clearing the traffic within the intersection in time and reducing traffic conflicts is achieved. Thereby, the invention provides a complete solution for actively identifying and controlling the entry behavior of motor vehicles during the phase change of the signal lights at urban road intersections. The detection is accurate, stable and efficient, with low cost and good adaptability. As shown in FIG. 1, the method comprises the following steps:

step 1: use the 3D LiDAR installed at the intersection covering the entrance of the urban intersection to obtain live vehicle trajectory data based on 3D LiDAR, and to detect the vehicles that are about to enter the intersection; specifically, the vehicle trajectory data comprises: the ID of the vehicle, the speed of the vehicle, the acceleration of the vehicle, and the distance of the vehicle from the stop line; the vehicle trajectory data or historical vehicle trajectory data are all divided into a straight-going vehicle data set, and/or a left-turning vehicle data set, and/or a right-turning vehicle data set;
the 3D LiDAR can be installed on the side of the entrance or on the door frame or sign pole. It is necessary to ensure a certain installation height, and the height is required to avoid the shade of green plants, sign boards, etc. Then the 3D LiDAR detects and perceives the vehicles within the entrance. This function is completed by the detection module of the system.

Step 2: map the vehicle trajectory data obtained by the 3D LiDAR into a three-dimensional coordinate system within the range of the entrance, and classify the vehicles according to the lane where the vehicle is located; the three-dimensional coordinate system is established before the vehicle trajectory data is obtained; the coordinates of the stop line at the intersection, the coordinates and range of the lane, and the information of the lane are input in the three-dimensional coordinate system;
by establishing a three-dimensional coordinate system within the range of the entrance, the coordinates of the stop line, the coordinates and range of the lane, and the information of the lane in the coordinate system are entered in advance. The 3D LiDAR obtains the coordinates of the vehicle relative to the radar by sensing the vehicle, maps it in the established coordinate system, and classifies the vehicle according to the lane where the vehicle is located. By assigning each vehicle ID, timestamp information, and the position of the vehicle moving in a certain time interval, the real-time driving speed and acceleration information of the vehicle can be obtained. This function is completed by the data processing module of the system.

Step 3: after receiving the start signal of the yellow light, input the vehicle trajectory data obtained within the first 1.5 s of the yellow light time into the trajectory prediction model; predict the vehicle trajectory within the last 1.5 s of the yellow light time based on the trajectory prediction model;
in the embodiment, the start signal of the yellow light specifically comprises the real-time phase information of the intersection, that is, the current phase and the duration of the current phase; through this information, the system can choose to predict and discriminate different types of vehicles;
specifically, after receiving the start signal of the yellow light, determine the phase of the yellow light at this time, and different phases need to predict and discriminate the corresponding lane vehicles. If it is the yellow light of the straight-going phase at this time, after receiving the start signal of the yellow light, the system only needs to predict and discriminate the vehicles on the straight-going lane at this time; if it is the yellow light of the left-turning phase at this time, after receiving the start signal of the yellow light, the system only needs to predict and discriminate the vehicles on the left-turning lane at this time. Based on the vehicle trajectory data obtained in the first 1.5 s of the yellow light time, the system predicts the passing trend of the vehicle after the yellow light ends.

When predicting and discriminating each vehicle entry, the system starts with the first vehicle in the queue, and then predicts and discriminates one by one; in the one-by-one discrimination, if it is judged that a certain vehicle will not enter the intersection at the end of the yellow light, all the vehicles in the queue after the vehicle are judged to not enter the intersection at the end of the yellow light;

step 4: based on the vehicle trajectory data within the last 1.5 s after the yellow light time, identify whether the vehicle will enter the intersection after the yellow change interval; if yes, continue to predict the travel time of all vehicles that have entered the intersection as a result of the prediction, and further filter to obtain the maximum time for the entered vehicle to leave the intersection; if not, return to step 1 to continue detection;
wherein, the travel time of the vehicle in the intersection refers to the time from when the vehicle enters the intersection at the end of the yellow light to when it leaves the intersection;
specifically, in the embodiment, the specific content of predicting the travel time of all vehicles that have entered the intersection as a result of the prediction is as follows:
within the range of the entrance, collect the data of the vehicles entering the intersection after the current phase yellow light ends and the red light is on, and predict the trajectory and travel time of the vehicle in the intersection according to the lane where the vehicle is located; if the vehicle is on the straight-going lane, its trajectory is predicted to go straight through the intersection and leave; if the vehicle is on the left-turning lane, its trajectory is predicted to turn left into the left road and leave the intersection;
based on the predicted speed of the vehicle entering the intersection at the end of the yellow light and the predicted trajectory of the vehicle within the intersection, by assuming that the vehicle will pass through the intersection at the end of the yellow light at a constant speed that the predicted vehicle enters the intersection, the travel time of the vehicle in the intersection can be predicted; compare the predicted travel time of each vehicle in the intersection to obtain the maximum time t for the entered vehicles to leave the intersection.

step 5: determine the all-red time of the intersection according to the obtained maximum time for the entered vehicles to leave the intersection; specifically, with the obtained maximum time t for the entered vehicles to leave the intersection, set the time t as a new all-red time, so as to ensure that the last entered vehicle can leave the intersection within the all-red time, which achieves the purpose of clearing the traffic within the intersection in time and reducing traffic conflicts between vehicles in different phases.

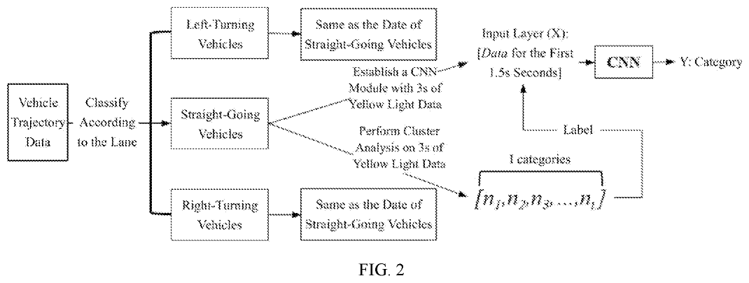

Specifically, in the embodiment, the trajectory prediction model in step 3 is established based on historical vehicle trajectory data, as shown in FIG. 2, and the establishment of the trajectory prediction model comprises the following steps:

step 3.1: collect historical vehicle trajectory data within 3 s of the yellow light time to form a vehicle trajectory data set A;

step 3.2: perform cluster analysis (the amount of data should be large enough, K-Means or DBSCAN) on the vehicle trajectory data set A to obtain cluster center trajectory data; divide the data of the vehicle trajectory data set A into i categories (the specific value of i is based on the result of clustering, and each intersection will be different) according to the clustering results; use the i categories as i trajectory labels, and each category corresponds to one trajectory label;

step 3.3: divide the vehicle trajectory data set A into a training set B and a test set C; take the trajectory data of the training set B and the trajectory label corresponding to each trajectory as input, establish a convolutional neural network (CNN) learning model to learn historical vehicle trajectory data and the corresponding label thereof;

step 3.4: train the model until the model is tested with the test set C; when the test value reaches the expected accuracy rate, the establishment of the trajectory prediction model is completed.

In the establishment process, the vehicle trajectory data within 1.5 s before the yellow light time of the above trajectory data is extracted as input, and the latter 1.5 s trajectory data is used as the result. Each piece of data is assigned a clear label to establish a supervised learning process.

Based on the above trajectory prediction model, in the embodiment, the step 3 specifically comprises the following steps:
input the vehicle trajectory data obtained in the first 1.5 s of the yellow light time into the trajectory prediction model established in advance, and the trajectory prediction model predicts and obtains the trajectory label to which the trajectory data belongs; according to the predicted trajectory label, select the trajectory data within the last 1.5 s after the yellow light time of the cluster center trajectory data (3 s) of the category corresponding to the trajectory label, which is the predicted trajectory data of the vehicle within the last 1.5 s after the yellow light time; then use the trajectory data to determine the passing trend of the vehicle after the yellow light ends and predict the trajectory data of the vehicle at the stop line.

Specifically, in the embodiment, the 3D LiDAR knows whether a single vehicle or a vehicle queue is passing in each lane of the entrance at this time by detecting the vehicles at the entrance of the intersection; the prediction in step 3 is divided into two scenarios: single vehicle passing prediction and vehicle queue passing prediction;
the specific prediction process for a single vehicle is: after receiving the start signal of the yellow light, determine the phase of the yellow light at this time, and different phases need to predict and discriminate the corresponding lane vehicles; if it is the yellow light of the straight-going phase at this time, after receiving the start signal of the yellow light, the system only needs to predict and discriminate the vehicles on the straight-going lane at this time; if it is the yellow light of the left-turning phase at this time, after receiving the start signal of the yellow light, the system only needs to predict and discriminate the vehicles on the left-turning lane at this time;
the specific prediction process for a vehicle queue is: when the 3D LiDAR collects vehicle trajectory data, all vehicles are collected together as a whole; when predicting and discriminating each vehicle entry, it starts with the first vehicle in the queue, and then predicts and discriminates one by one; in the one-by-one discrimination, if it is judged that a certain vehicle will not enter the intersection at the end of the yellow light, all the vehicles in the queue after the vehicle are judged to not enter the intersection at the end of the yellow light.

The invention is based on high-precision 3D LiDAR technology and vehicle trajectory prediction technology to help identify dangerous behaviors during the phase change of traffic signals, and predict these dangerous behaviors in real time and adjust the all-red time in time. The purpose of clearing the traffic within the intersection in time and reducing traffic conflicts is achieved. In turn, it can reduce the phase change of the vehicle at the intersection, effectively help prevent and solve the hidden traffic hazards in the signal control intersection, and improve the driving safety of the driver within the intersection range.

The above embodiments are only preferred specific implementations of the invention, and the protection scope of the invention is not limited thereto. Any simple modification or equivalent replacement of the technical solution that can be easily obtained by those skilled in the art within the technical scope disclosed in the invention shall all fall within the protection scope of the invention.

1. A method for traffic clearance at signalized intersections based on lidar and trajectory prediction, comprising the following steps:
step 1: use the 3D LiDAR installed at the intersection covering the entrance of the urban intersection to obtain live vehicle trajectory data based on 3D LiDAR, and to detect the vehicles that are about to enter the intersection;
step 2: map the vehicle trajectory data obtained by the 3D LiDAR into a three-dimensional coordinate system within the range of the entrance, and classify the vehicles according to the lane where the vehicle is located;
step 3: after receiving the start signal of the yellow light, input the vehicle trajectory data obtained within the first 1.5 s of the yellow light time into the trajectory prediction model; predict the vehicle trajectory within the last 1.5 s of the yellow light time based on the trajectory prediction model;
step 4: based on the vehicle trajectory data within the last 1.5 s after the yellow light time, identify whether the vehicle will enter the intersection after the yellow change interval; if yes, continue to predict the travel time of all vehicles that have entered the intersection as a result of the prediction, and further filter to obtain the maximum time for the entered vehicle to leave the intersection; if not, return to step 1 to continue detection;
wherein, the travel time of the vehicle in the intersection refers to the time from when the vehicle enters the intersection at the end of the yellow light to when it leaves the intersection;
step 5: determine the all-red time of the intersection according to the obtained maximum time for the entered vehicles to leave the intersection.

2. The method for traffic clearance at signalized intersections based on lidar and trajectory prediction according to claim 1, wherein the three-dimensional coordinate system is established before the vehicle trajectory data is obtained; the coordinates of the stop line at the intersection, the coordinates and range of the lane, and the information of the lane are input in the three-dimensional coordinate system.

3. The method for traffic clearance at signalized intersections based on lidar and trajectory prediction according to claim 1, wherein the vehicle trajectory data comprises: the ID of the vehicle, the speed of the vehicle, the acceleration of the vehicle, and the distance of the vehicle from the stop line; the start signal of the yellow light specifically comprises the real-time phase information of the intersection, that is, the current phase and the duration of the current phase.

4. The method for traffic clearance at signalized intersections based on lidar and trajectory prediction according to claim 1, wherein the trajectory prediction model in step 3 is established based on historical vehicle trajectory data, and the establishment of the trajectory prediction model comprises the following steps:
step 3.1: collect historical vehicle trajectory data within 3 s of the yellow light time to form a vehicle trajectory data set A;
step 3.2: perform cluster analysis on the vehicle trajectory data set A to obtain cluster center trajectory data; divide the data of the vehicle trajectory data set A into i categories according to the clustering results; use the i categories as i trajectory labels, and each category corresponds to one trajectory label;
step 3.3: divide the vehicle trajectory data set A into a training set B and a test set C; take the trajectory data of the training set B and the trajectory label corresponding to each trajectory as input, establish a convolutional neural network learning model to learn historical vehicle trajectory data and the corresponding label thereof;
step 3.4: train the model until the model is tested with the test set C; when the test value reaches the expected accuracy rate, the establishment of the trajectory prediction model is completed.

5. The method for traffic clearance at signalized intersections based on lidar and trajectory prediction according to claim 4, wherein the vehicle trajectory data or historical vehicle trajectory data are all divided into a straight-going vehicle data set, and/or a left-turning vehicle data set, and/or a right-turning vehicle data set.

6. The method for traffic clearance at signalized intersections based on lidar and trajectory prediction according to claim 5, wherein the step 3 specifically comprises the following steps:
input the vehicle trajectory data obtained in the first 1.5 s of the yellow light time into the trajectory prediction model established in advance, and the trajectory prediction model predicts and obtains the trajectory label to which the trajectory data belongs; according to the predicted trajectory label, select the trajectory data within the last 1.5 s after the yellow light time of the cluster center trajectory data of the category corresponding to the trajectory label, which is the predicted trajectory data of the vehicle within the last 1.5 s after the yellow light time; then use the trajectory data to determine the passing trend of the vehicle after the yellow light ends and predict the trajectory data of the vehicle at the stop line.

7. The method for traffic clearance at signalized intersections based on lidar and trajectory prediction according to claim 6, wherein the 3D LiDAR knows whether a single vehicle or a vehicle queue is passing in each lane of the entrance at this time by detecting the vehicles at the entrance of the intersection; the prediction in step 3 is divided into two scenarios: single vehicle passing prediction and vehicle queue passing prediction;
the specific prediction process for a single vehicle is: after receiving the start signal of the yellow light, determine the phase of the yellow light at this time, and different phases need to predict and discriminate the corresponding lane vehicles; if it is the yellow light of the straight-going phase at this time, after receiving the start signal of the yellow light, the system only needs to predict and discriminate the vehicles on the straight-going lane at this time; if it is the yellow light of the left-turning phase at this time, after receiving the start signal of the yellow light, the system only needs to predict and discriminate the vehicles on the left-turning lane at this time;
the specific prediction process for a vehicle queue is: when the 3D LiDAR collects vehicle trajectory data, all vehicles are collected together as a whole; when predicting and discriminating each vehicle entry, it starts with the first vehicle in the queue, and then predicts and discriminates one by one; in the one-by-one discrimination, if it is judged that a certain vehicle will not enter the intersection at the end of the yellow light, all the vehicles in the queue after the vehicle are judged to not enter the intersection at the end of the yellow light.

8. The method for traffic clearance at signalized intersections based on lidar and trajectory prediction according to claim 7, wherein the specific content of predicting the travel time of all vehicles that have entered the intersection as a result of the prediction is as follows:
within the range of the entrance, collect the data of the vehicles entering the intersection after the current phase yellow light ends and the red light is on, and predict the trajectory and travel time of the vehicle in the intersection according to the lane where the vehicle is located; if the vehicle is on the straight-going lane, its trajectory is predicted to go straight through the intersection and leave; if the vehicle is on the left-turning lane, its trajectory is predicted to turn left into the left road and leave the intersection;
based on the predicted speed of the vehicle entering the intersection at the end of the yellow light and the predicted trajectory of the vehicle within the intersection, by assuming that the vehicle will pass through the intersection at the end of the yellow light at a constant speed that the predicted vehicle enters the intersection, the travel time of the vehicle in the intersection can be predicted; compare the predicted travel time of each vehicle in the intersection to obtain the maximum time t for the entered vehicles to leave the intersection.

9. The method for traffic clearance at signalized intersections based on lidar and trajectory prediction according to claim 8, wherein the specific content of determining the all-red time of the intersection is:
with the obtained maximum time t for the entered vehicles to leave the intersection, set the time t as a new all-red time, so as to ensure that the last entered vehicle can leave the intersection within the all-red time.

10. A system traffic clearance at signalized intersections based on lidar and trajectory prediction, comprising a detection module, a data processing module, a data prediction module, and a signal control management module;
the detection module is configured to obtain the vehicle trajectory data at the entrance of the urban intersection;
the data processing module is configured to analyze and process the obtained vehicle trajectory data;
the data prediction module is configured to predict the trajectory of the vehicle, identify whether the vehicle will enter the intersection, and predict the travel time of the entered vehicle in the intersection;
the signal control management module is configured to obtain the information of the signal light and adjust the all-red time of the signal light.
